(19) United States
(12) Patent Application Publication
(10) Pub. No.: US 2026/0026437 A1
(43) Pub. Date: Jan. 29, 2026

(54) Pull-Type Crop Harvesting Apparatus

(71) Applicant: MacDon Industries LTD, Winnipeg (CA)

(72) Inventors: Matthew Stephens, Niverville (CA); Neil Barnett, LaSalle (CA); Brent Fletcher, Winnipeg (CA); Mathieu Fillion, Winnipeg (CA)

(21) Appl. No.: 19/280,967

(22) Filed: Jul. 25, 2025

Related U.S. Application Data
(60) Provisional application No. 63/676,134, filed on Jul. 26, 2024.

(51) Int. Cl. A01D 41/14

(52) U.S. Cl. CPC A01D 41/144; A01D 41/145

(57) ABSTRACT

A crop harvesting apparatus for use with an agricultural machine. The crop harvesting apparatus may be towed behind an agricultural machine, such as a tractor. The crop harvesting apparatus includes a center frame configured to be coupled to the agricultural machine. The crop harvesting apparatus further includes a pair of wing members each coupled to the center frame and pivotable about a respective wing axis for movement between a transport position and a field position. A first header assembly and a second header assembly are each coupled to one of the wing members and pivotable about a respective suspension axis. The first header assembly is independently pivotable from the second header assembly.

### CROSS-REFERENCE TO RELATED APPLICATIONS

The subject patent application claims priority to, and all the benefits of, United States Provisional Patent Application No. 63/676,134, filed on Jul. 26, 2024, the entire contents of which are incorporated by reference herein.

### BACKGROUND

Crops are commonly harvested by a harvesting apparatus attached to an agricultural machine, such as a tractor, which moves the harvesting apparatus through a field of harvestable crops. One method for increasing the efficiency with which the crops are harvested is to increase the size of the harvesting apparatus, typically by widening the width of the harvesting apparatus. A wider harvesting apparatus allows more crops to be harvested at the same time thereby reducing the time required to harvest a field of a given area. However, increasing the size of the harvesting apparatus has several disadvantages such as increased weight, which may exceed the weight limit that the tractor is capable of carrying. Additionally, a wider harvesting apparatus may have difficulty following uneven terrain in a field, which may prevent the harvesting apparatus from cutting the crop as closely to the ground as desired and reducing crop yield. Finally, a wider harvesting apparatus can complicate normal transport of the apparatus to and from the field. A harvesting apparatus that overcomes one or more of the disadvantages above is desired.

### SUMMARY

In one aspect, a crop harvesting apparatus for use with an agricultural machine is disclosed. The crop harvesting apparatus includes a center frame, a pair of wing members, a first header assembly, and a second header assembly. The center frame is configured to be coupled to the agricultural machine. The pair of wing members are each coupled to the center frame and pivotable about a respective wing axis for movement between a transport position and a field position. The first header assembly and the second header assembly are each coupled to one of the wing members and pivotable about a respective suspension axis. The first header assembly is independently pivotable from the second header assembly.

In another aspect, a crop harvesting apparatus for use with an agricultural machine is disclosed. The crop harvesting apparatus includes a center frame, a first wing member, and a second wing member. The center frame is configured to be coupled to the agricultural machine. The first wing member includes a first header assembly coupled to the center frame and pivotable about a first wing axis for movement between a transport position and a field position. The second wing member includes a second header assembly coupled to the center frame and pivotable about a second wing axis for movement between a transport position and a field position. The first wing member and the second wing member are independently pivotable.

In another aspect, a method for operating a crop harvesting apparatus behind an agricultural machine is disclosed. The crop harvesting apparatus includes a center frame, a first wing member and a second wing member each coupled to the center frame and pivotable about a respective vertical wing axis. The crop harvesting apparatus further includes a first header assembly coupled to the first wing member and a second header assembly coupled to the second wing member. The method includes a step of pivoting the first and second wing members from a transport position in which the first header assembly and the second header assembly are arranged behind the center frame to a field position in which the first header assembly and the second header assembly are arranged on opposing sides of the center frame.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a perspective view of a tractor and a harvesting apparatus arranged behind the tractor. The harvesting apparatus includes a center section and two arm sections with the arm sections arranged in a field position.

FIG. 2 is a perspective view of the tractor and harvesting apparatus of FIG. 1 with the arm sections of the harvesting apparatus arranged in a transport position.

FIG. 3 is a top view of the tractor and harvesting apparatus of FIG. 1.

FIG. 4 is a side view of the harvesting apparatus of FIG. 1 showing the center section and one of the arm sections and a first header assembly.

FIG. 5 is a close-up side view of the harvesting apparatus of FIG. 4 showing the center section, which includes a center frame and a coupler frame.

FIG. 6 is a perspective view of the center section of FIG. 5 showing the center frame and the coupler frame.

FIG. 7 is another perspective view of the center section of FIG. 5 showing the center frame and the coupler frame.

FIG. 8 is another perspective view of the center section of FIG. 5 showing the center frame and the coupler frame.

FIG. 9 is a front perspective view of the harvesting apparatus of FIG. 1 showing one of the arm sections and the first header assembly.

FIG. 10 is rear perspective view of the harvesting apparatus of FIG. 1 showing the center section and the two arm sections.

FIG. 11 is a side view of the tractor and harvesting apparatus of FIG. 2 showing the arm sections in the transport position.

FIG. 12 is a front perspective view of the harvesting apparatus of FIG. 11 showing the center section and the two arm sections in the transport position.

FIG. 13 is a top view of the harvesting apparatus of FIG. 11.

FIG. 14 is a top view of the tractor and harvesting apparatus of FIG. 1 showing the arm sections arranged in a turning configuration.

FIG. 15 is a close up top view of the harvesting apparatus of FIG. 14 showing the center section with the arm sections arranged in the turning configuration.

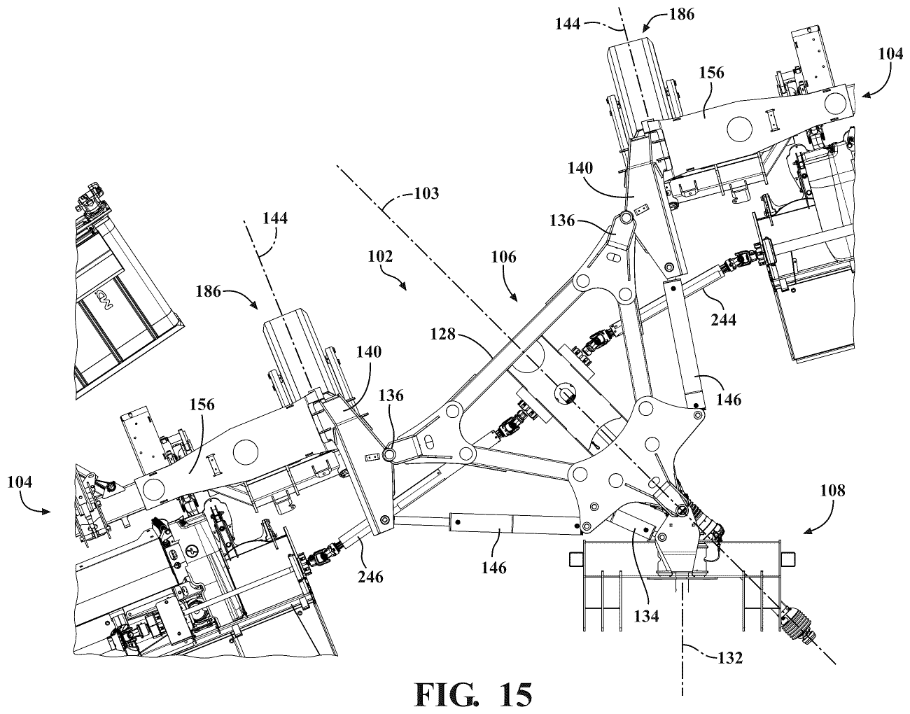

FIG. 16 is a perspective view of the harvesting apparatus of FIG. 1 showing an outer wheel assembly in a field position.

FIG. 17 is a perspective view of the harvesting apparatus of FIG. 2 showing an outer wheel assembly in a field position.

FIG. 18 is a close-up perspective view of an inner end of one of the arm sections and an inner wheel assembly, with the arm section arranged in the field position and the inner wheel assembly arranged in the transport position.

FIG. 19 is a close-up perspective view of the inner end of one of the arm sections and the inner wheel assembly, with the arm section and the inner wheel assembly arranged in the field position.

### DETAILED DESCRIPTION

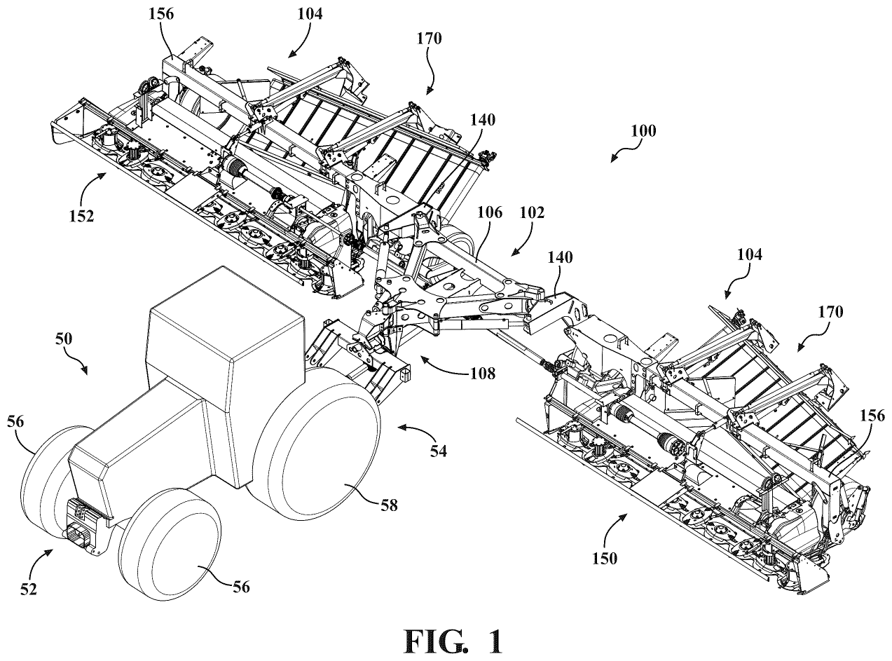

In FIGS. 1-3, a harvesting apparatus 100 for harvesting crops is shown coupled to an agricultural machine 50, for example a traditional style tractor 50. In general, the tractor 50 has a front 52 and a rear 54 longitudinally spaced along a longitudinal tractor axis 60 and associated with forward and reverse directions of travel. The tractor 50 illustrated herein comprises front wheels 56 and rear wheels 58 arranged proximate the corresponding front 52 and rear 54 thereof. It will be appreciated that the tractor 50 may be configured as shown with wheels, or may utilize other propulsion configurations such as tracks, or a combination of tracks and wheels (not shown). Best shown in FIG. 1, each of the front wheels 56 is arranged on one side of the tractor 50 and laterally spaced from the other. Similarly, each of the rear wheels 58 is arranged on one side of the tractor 50 and laterally spaced from the other.

The tractor 50 is used to operate and control the harvesting apparatus 100 by providing power, via a tractor PTO system. The tractor 50 may further include a hydraulic system, which pumps hydraulic fluid to the harvesting apparatus 100, and is utilized to actuate and control various components of the harvesting apparatus 100. The tractor 50 further comprises a hitch (not shown) arranged at the rear 54 to couple the harvesting apparatus 100 to the rear 54 and enable the harvesting apparatus 100 to be pulled by the tractor 50. Here, the hitch is a three-point hitch, which may comprise a pair of lifting arms and a top link. The lifting arms and top link may be powered by the hydraulic system to pivot between a raised position and a lowered position for controlling a height of the harvesting apparatus 100.

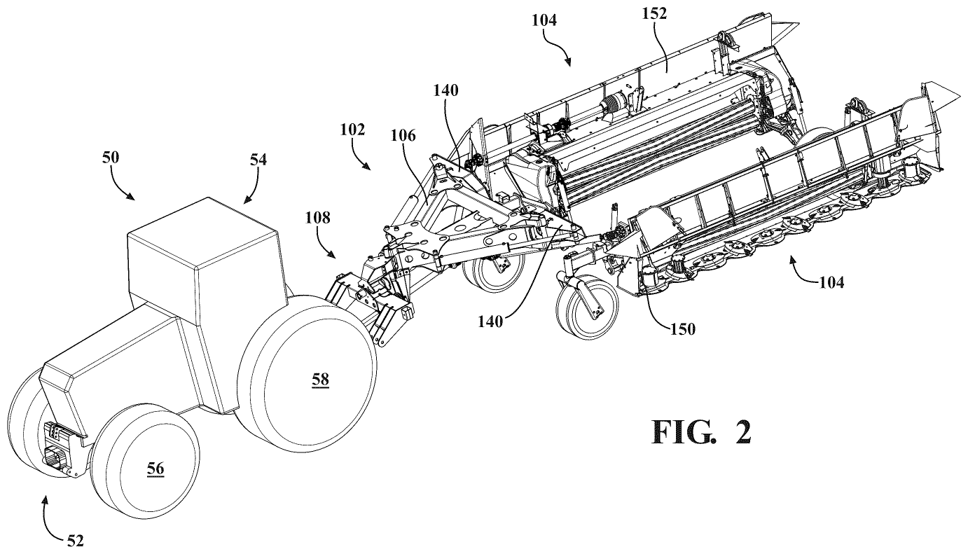

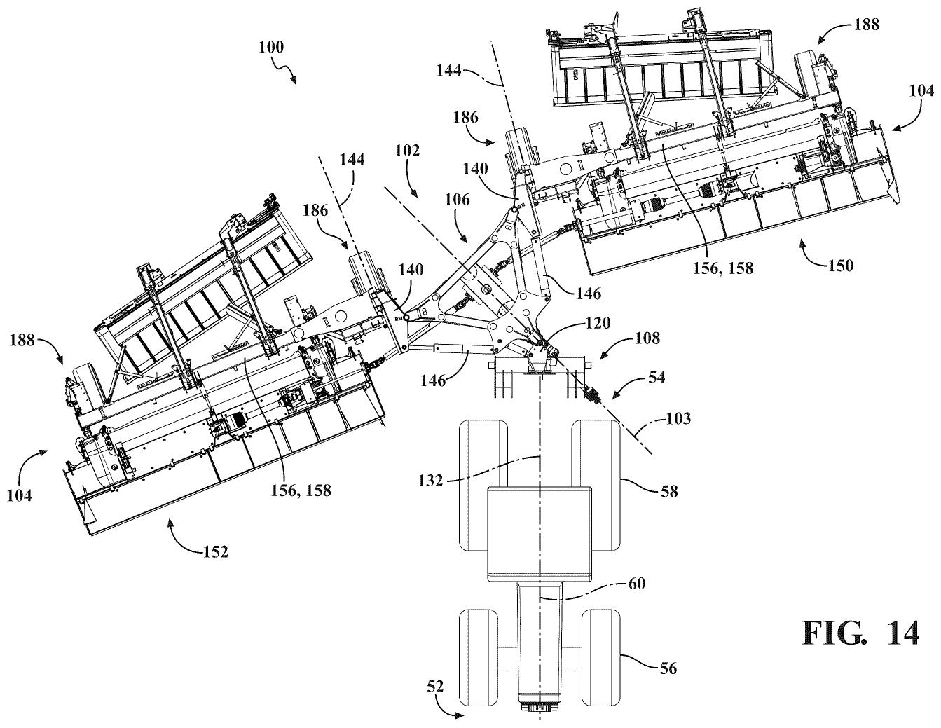

The harvesting apparatus 100 illustrated herein comprises a center section 102 defining a centerline 103 and two arm sections 104 arranged on opposing lateral sides of the center section 102. The center section 102 is generally arranged with the centerline 103 of the center section 102 aligned with the tractor axis 60 of the tractor 50. Each of the arm sections 104 is coupled to the center section 102 and is movable between a field position (FIG. 1) and a transport position (FIG. 2). In the field position, the arm sections 104 extend from the center section 102 generally perpendicular to the centerline 103 and in the transport position the arm sections 104 extend generally parallel to the centerline 103. Said differently, in the transport position the arm sections 104 are arranged behind the center section 102 and in the field position the arm sections 104 are arranged on opposing sides of the center section 102. In the field position, the arm sections 104 are positioned to maximize the width of the harvesting apparatus 100 to increase the speed and efficiency of harvesting crops. In the transport position, the arm sections 104 are positioned to minimize the width of the harvesting apparatus 100 to facilitate transportation via existing infrastructure (i.e., roads and/or buildings) between fields to be harvested. Each of the arm sections 104 is further movable to place the harvesting apparatus 100 in a turning configuration (FIG. 14). As will be discussed in further detail below one of the arm sections 104 is positioned forward relative to the center section 102 while the other of the arm sections 104 is positioned reward relative to the center section 102 to adjust a harvesting path of the crop harvesting apparatus 100. When the tractor 50 is turning (such as at the end of a row of crops), the crop harvesting apparatus 100 is moved into the turning configuration to shift the harvesting path and avoid missed crops.

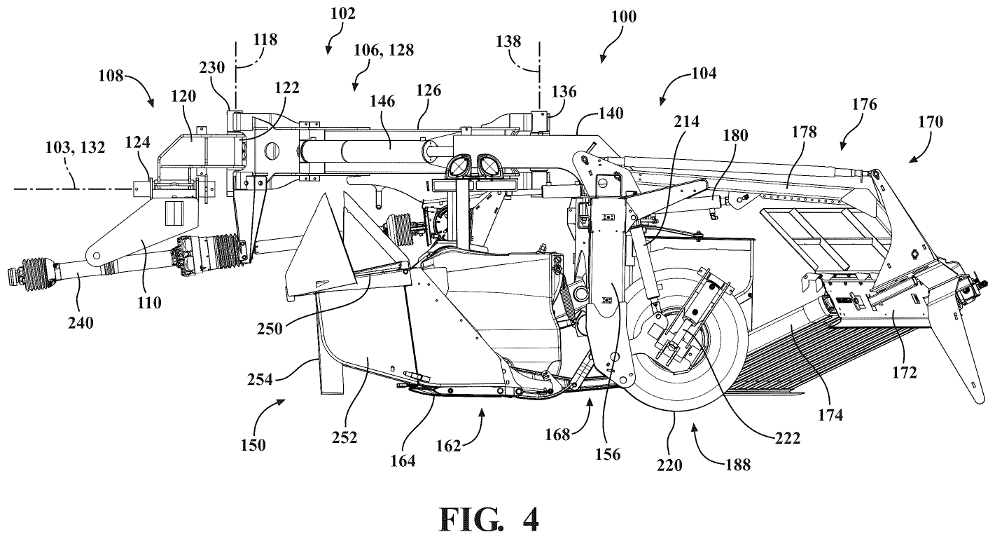

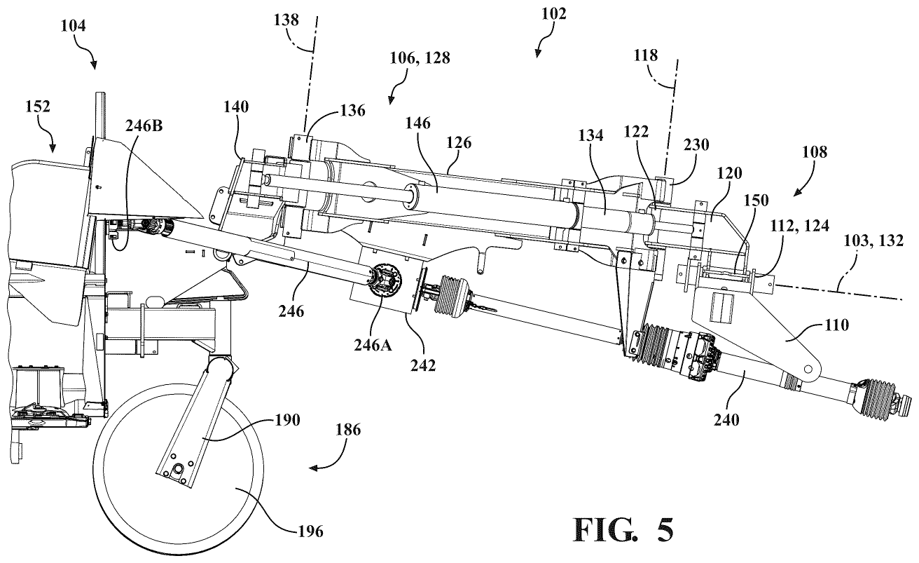

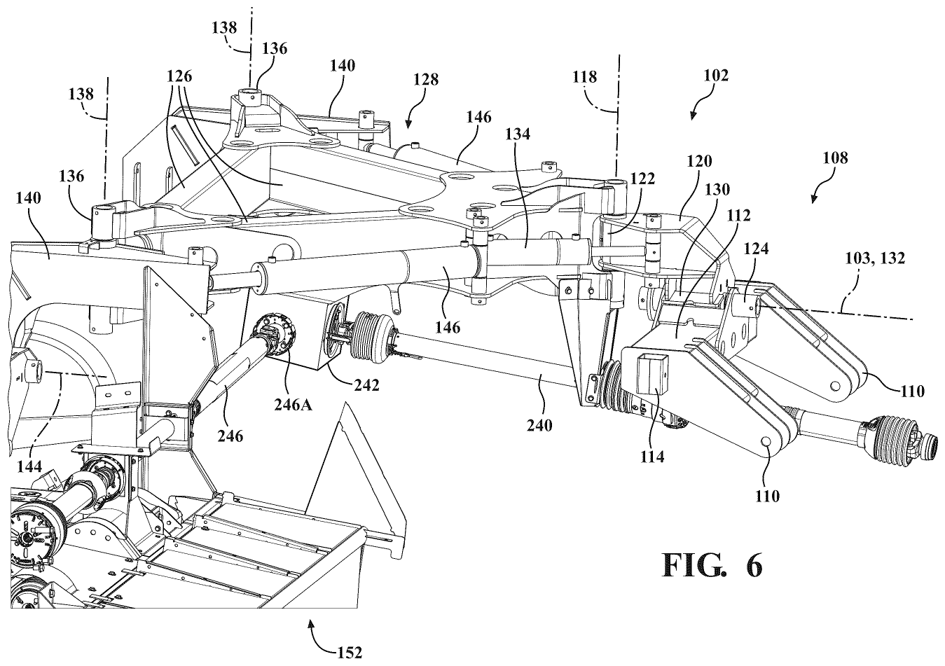

Turning to FIGS. 4-8, the center section 102 includes a center frame 106 and a coupler frame 108. The coupler frame 108 includes two legs 110 coupled to a crossbar 112 and is configured to be coupled to the hitch of the tractor 50. More specifically, the legs 110 are configured to engage with the lift arms of the hitch and the crossbar 112 is configured to engage with the top link. The coupler frame 108 may further include one or more leg pockets 114 configured to receive height adjustable landing legs to support the coupler frame 108 on the ground when disconnected from the tractor 50. The coupler frame 108 further includes a pair of roll sockets 124 coupled to the crossbar 112. The pair of roll sockets 124 are spaced from each other along a coupler roll axis 132 and are configured to operably couple a neck member 120 to the coupler frame 108.

To this end, the center section 102 further includes the neck member 120, which is coupled to the coupler frame 108 for pivoting movement about the coupler roll axis 132. The neck member 120 is arranged generally aligned with the coupler roll axis 132 and the centerline 103 of the harvesting apparatus 100. As such, the coupler roll axis 132 is arranged generally parallel to the centerline 103 of the harvesting apparatus 100 so as to align with the tractor axis 60 of the tractor 50 during operation. The neck member 120 includes a roll joint 130 operably engaged with the pair of roll sockets 124 to facilitate the pivoting movement about the coupler roll axis 132. Here, the roll joint 130 and the roll sockets 124 are shown as cylindrical couplers configured to receive a pivot axle (not shown) to pivotably couple the roll joint 130 to the roll sockets 124.

The neck member 120 is further coupled to the center frame 106 for pivoting movement about a coupler yaw axis 118. The coupler yaw axis 118 is arranged generally vertically and perpendicular to the coupler roll axis 132. To this end, the neck member 120 includes a yaw joint 122 aligned with the coupler yaw axis 118 and configured to operably engage with the center frame 106 to facilitate pivoting movement about the coupler yaw axis 118 (i.e., the center frame 106 is able to pivot left and right relative to the neck member 120).

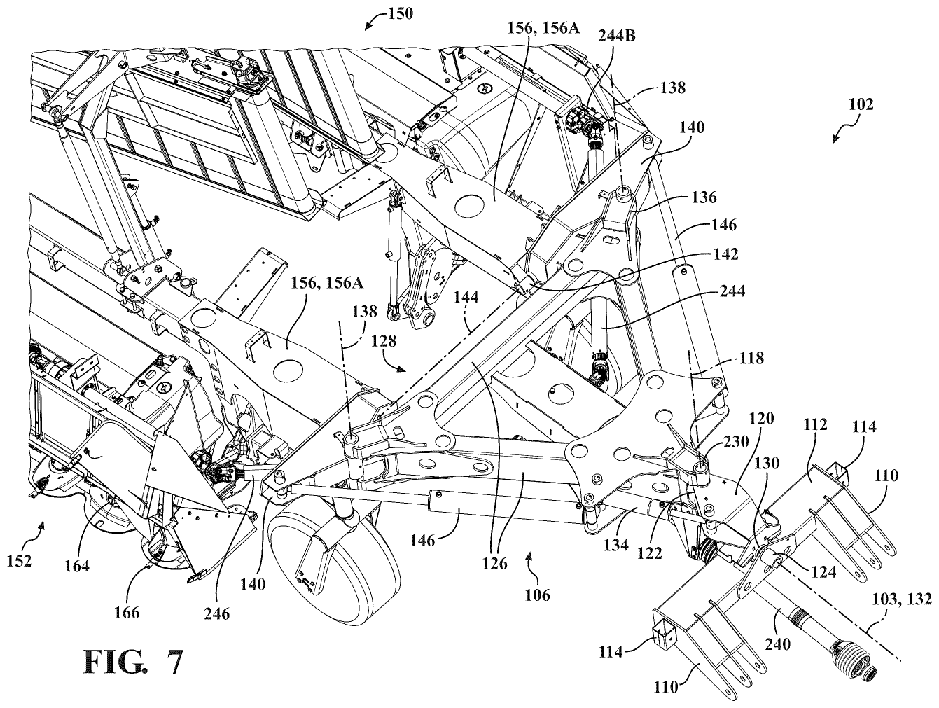

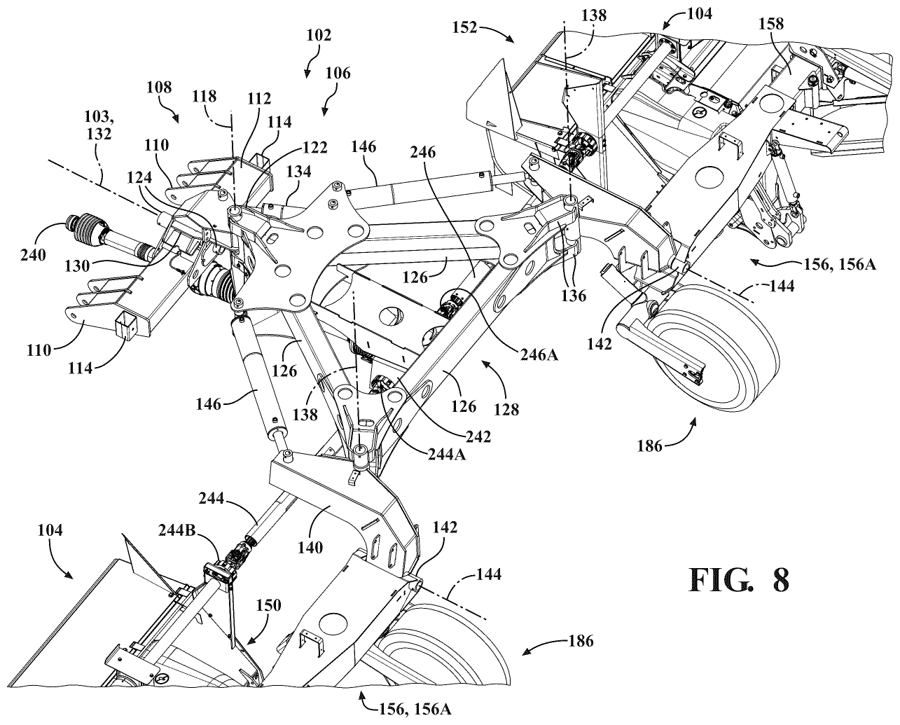

Best shown in FIGS. 7-8, the center frame 106 includes several frame beams 126 arranged to form a generally triangular member 128 aligned with the centerline 103 of the center section 102. The center frame 106 further includes a pair of yaw sockets 230 spaced from each other along the coupler yaw axis 118 and configured to operably couple the neck member 120 to the triangular member 128 of the center frame 106. The yaw sockets 230 are operably engaged with the yaw joint 122 to facilitate the pivoting movement of the center frame 106 about the yaw axis 118. Here, the yaw joint 122 and the yaw sockets 230 are shown as cylindrical couplers configured to receive a pivot axle (not shown) to pivotably couple the yaw joint 122 to the yaw sockets 230.

As will be discussed in further detail below, the harvesting apparatus 100 includes a yaw damper 134 coupled between the center frame 106 and the neck member 120 and movable in response to pivoting of the center frame 106 relative to the neck member 120 about the coupler yaw axis 118. The implementation of the harvesting apparatus 100 illustrated herein includes a single yaw damper 134, however other implementations (not shown) may utilize a pair of yaw dampers arranged on alternate sides of the center section 102. During operation the harvesting apparatus 100 may become unstable about the coupler yaw axis 118. Such instability may be cyclic movement as a harmonic of speed, or may be a constant offset due to a slope or grade of the field being harvested. In a first operating mode, the yaw damper 134 may pivot the center frame 106 relative to the coupler frame 108 to offset the angle of the arm sections 104 a certain degree. In a second operating mode, the yaw damper 134 may absorb movement of the center frame 106 relative to the coupler frame 108 to damp cyclic instabilities. The yaw damper 134 may be actuated to absorb movement using sensors (not shown) that measure the frequency and amplitude of any oscillations of the center frame 106 and direct the yaw damper 134 to counteract the movement. Alternatively or additionally, the yaw damper 134 may be passive dampers, which damp oscillations of the center frame 106. When the yaw damper 134 are implemented as passive dampers, the harvesting apparatus 100 may include a hydraulic system include a variable pressure relief valve. The variable pressure relief valve allows pressure in the hydraulic system above a predetermined threshold to be released (e.g., when an oscillation force acts on the yaw damper 134). In some embodiments, the hydraulic system of the harvesting apparatus 100 may receive pressure from the tractor 50.

Referring to FIGS. 7-8, the center frame 106 further includes a pair of wing mounts 136 coupled to the triangular member 128 and each defining a wing pivot axis 138. The wing pivot axes 138 are arranged generally vertical and parallel to the coupler yaw axis 118. Each of the wing mounts 136 is arranged on an opposing side of the coupler roll axis 132.

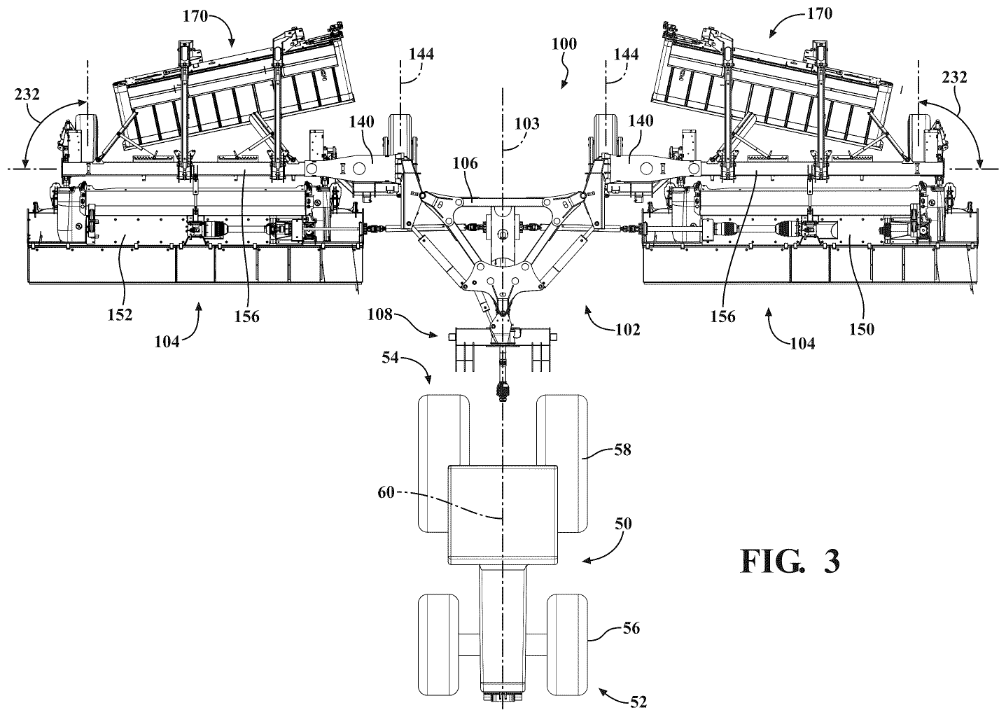

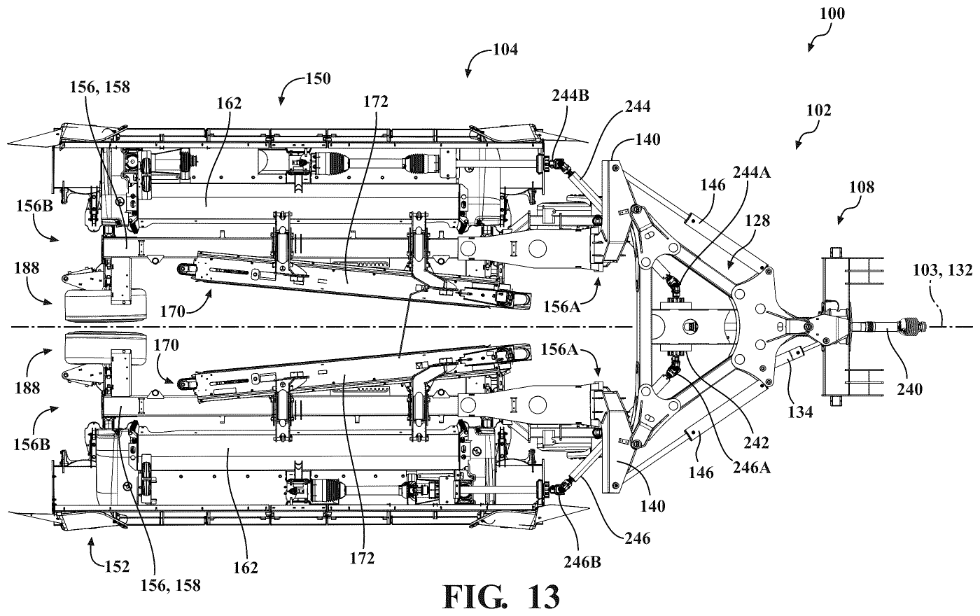

In order to facilitate moving the arm sections 104 between the field position and the transport position, the harvesting apparatus 100 further includes a pair of wing members 140 each pivotably coupled to the center frame 106. Specifically, the wing members 140 are each pivotably coupled to one of the wing mounts 136 and movable between a field position and a transport position corresponding to the corresponding positions of the arm sections 104. Each of the wing members 140 includes an arm mount 142 arranged at one end of the wing member 140. Each of the arm mounts 142 defines a respective suspension axis 144, each of which is arranged generally horizontal and parallel to the coupler roll axis 132. When the tractor 50 is pulling the harvesting apparatus 100 in a straight direction (i.e., not turning) and the arm sections 104 are in the field position (FIG. 3), the suspension axes 144 are oriented parallel to the coupler roll axis 132 and the centerline 103. When the arm sections 104 are in the transport position (FIG. 13) the suspension axes 144 are oriented perpendicular to the coupler roll axis 132 and the centerline 103. In order to pivot the wing members 140 between the field position and the transport position, the harvesting apparatus 100 further includes a pair of wing actuators 146 coupled between the wing members 140 and the center frame 106. More specifically, the wing actuators 146 are each coupled between a respective one of the wing members 140 and the triangular member 128 and operable to move the respective wing member 140 between the field position and the transport position. Each wing actuator 146 is coupled to one of the wing members 140 at an end opposite to the arm mount 142 and the wing member 140 is coupled to the center frame 106 at a pivot point between the ark mount 142 and the wing actuator 146. Here the wing actuators 146 are implemented as hydraulic cylinders. Other actuator types and configurations are contemplated.

The harvesting apparatus 100 further includes a drive system for receiving power from the tractor 50. Specifically, the harvesting apparatus 100 includes an input driveshaft 240 coupled between the PTO of the tractor 50 and a gearbox 242. The gearbox 242 is supported by the center frame 106 and splits power provided from the PTO via the input driveshaft 240 to two output driveshafts. The two output driveshafts are a first extendable driveshaft section 244 and a second extendable driveshaft section 246. The first extendable driveshaft section 244 has a first end 244A and a second end 244B. The first end 244A of the first extendable driveshaft section 244 is coupled to the gearbox 242 and operably supported by center frame 106. The second end 244B of the first extendable driveshaft section 244 is operably coupled to a first header assembly 150 (discussed below) to provide power to the first header assembly 150. The second extendable driveshaft section 246 has a first end 246A and a second end 246B. The first end 246A of the second extendable driveshaft section 246 is coupled to the gearbox 242 and operably supported by center frame 106. The second end 246B of the second extendable driveshaft section 246 is operably coupled to a second header assembly 152 (discussed below) to provide power to the second header assembly 152. The first and second extendable driveshaft sections 244, 246 facilitate the pivoting movement of the arm sections 104 relative to the center section 102. When each arm section 104 moves from the field position to the transport position, the length of the first and second extendable driveshaft sections 244, 246 increases in a corresponding manner. Each of the first ends 244A, 246A and second ends 246A, 246B includes a U-joint. In alternative implementations, the U-joint may be implemented with a CV joint or similar. The gearbox 242 is shown here as a right angle gearbox with one input and two outputs. It is contemplated that the gearbox 242 may include a differential to accommodate a speed difference between the two outputs.

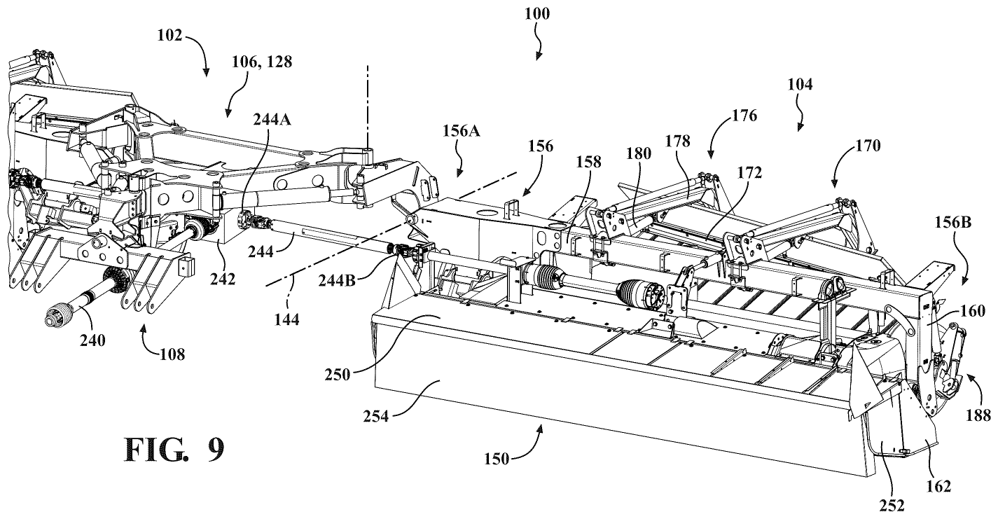

As shown in FIGS. 9-12, in order to harvest crops in a field, the harvesting apparatus 100 includes two header assemblies. Specifically, the harvesting apparatus 100 includes a first header assembly 150 and a second header assembly 152. The first header assembly 150 and the second header assembly 152 are substantially similar to one another with the differences generally facilitating their arrangement on opposing left and right sides of the center section 102. To this end, each of the first header assembly 150 and the second header assembly 152 includes a carrier frame 156, which includes a top beam 158 and two side beams 160 coupled to the top beam 158. Each carrier frame 156 extends from an inner end 156A to an outer end 156B. The inner end 156A of each carrier frame 156 is pivotably coupled to one of the wing members 140. More specifically, each top beam 158 is coupled to one of the arm mounts 142 for pivoting movement about the respective suspension axis 144. The pivoting connection between each carrier frame 156 and the respective wing member 140 facilitates pivoting movement of each of the first header assembly 150 and the second header assembly 152. Additionally, each of the first header assembly 150 and the second header assembly 152 are independently pivotable about the respective suspension axis 144.

In the exemplary implementation of the crop harvesting apparatus 100 illustrated herein, the first and second header assemblies 150, 152 are realized as rotary mowers. To this end, each of the first header assembly 150 and the second header assembly 152 includes a header frame 162 operably coupled to the carrier frame 156 and a cutterbar 164 coupled to the header frame 162. Each cutterbar 164 includes a plurality of cutting discs 166 that rotate to cut the crops. The first and second header assemblies 150, 152 further include a lift system 168 operably coupled between the header frame 162 and the respective carrier frame 156. The lift system 168 facilitates selective height adjustment of the header frame 162 and the cutterbar 164 relative to the carrier frame 156 and the ground.

Turning to FIG. 9, the header frame 162 of each of the first and second header assemblies 150, 152 may include a top wall 250 and two sidewalls 252. The top wall 250 extends along a length of the respective header assembly 150, 152 between the two sidewalls 252 to enclose the cutterbar 164. Each of the first and second header assemblies 150, 152 may further include a front curtain 254 coupled to the top wall 250 and extending between the two sidewalls. The exemplary header assemblies 150, 152 shown here are configured to fold the top wall 250, the sidewalls 252, and the front curtain 254 to decrease the size of the header assemblies 150, 152 when the arm sections 104 are in the transport position. The top wall 250 is pivotable upward and the sidewalls 252 are pivotable inward against the front curtain 254. By folding the top wall 250, the sidewalls 252, and the front curtain 254, the width of the harvesting apparatus 100 is decreased when the arm sections 104 are in the transport position.

As mentioned above, each of the carrier frames 156 is independently pivotable about the respective suspension axis 144. For example, the outer end 156B of the carrier frame 156 arranged on the left is able to pivot upwards while the outer end 156B of the carrier frame 156 arranged on the right is able to pivot downwards or remain horizontal and vice versa. Likewise, the outer ends 156B of both of the left and right carrier frames 156 are able to pivot upwards. When the arm sections 104 are arranged in the field position, the independent pivoting movement of each of the carrier frames 156 allows each carrier frame 156 to follow the contours of the field being harvested such that the header assemblies 150, 152 remain close to the ground. Movement of the center frame 106 relative to the coupler frame 108 about the coupler roll axis 132 provides further range of movement to each of the carrier frames 156 to facilitate the header assemblies 150, 152 closely following the ground. When the carrier frame 156 is close to the ground, a float geometry of the header lift system 168 is improved, which allows the header assemblies 150, 152 to cut the crops closer to the ground. When the arm sections 104 are arranged in the transport position, the independent pivoting movement of each of the carrier frames 156 allows each carrier frame 156 to react to imperfections in a road surface (e.g., a pothole) while the harvesting apparatus 100 is being transported.

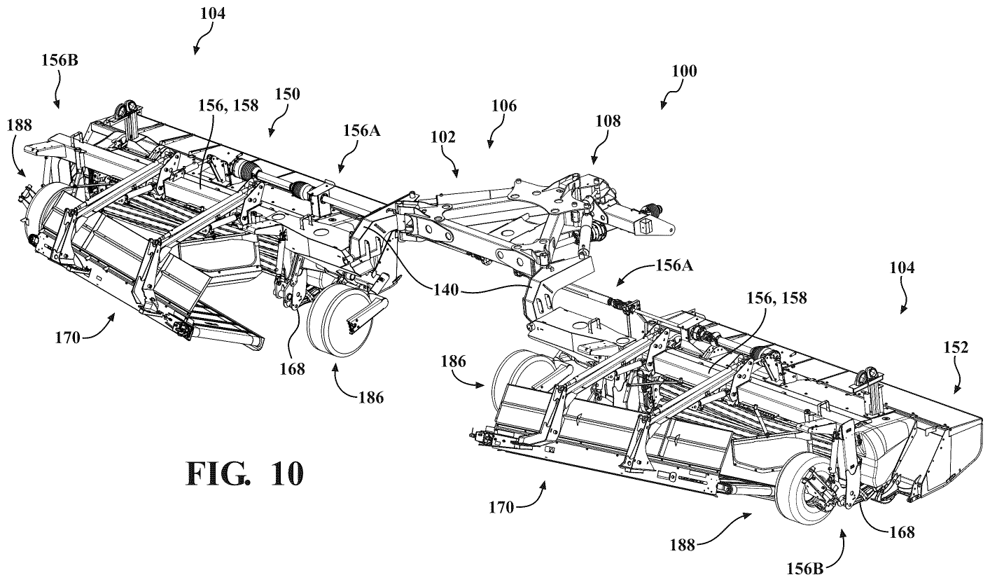

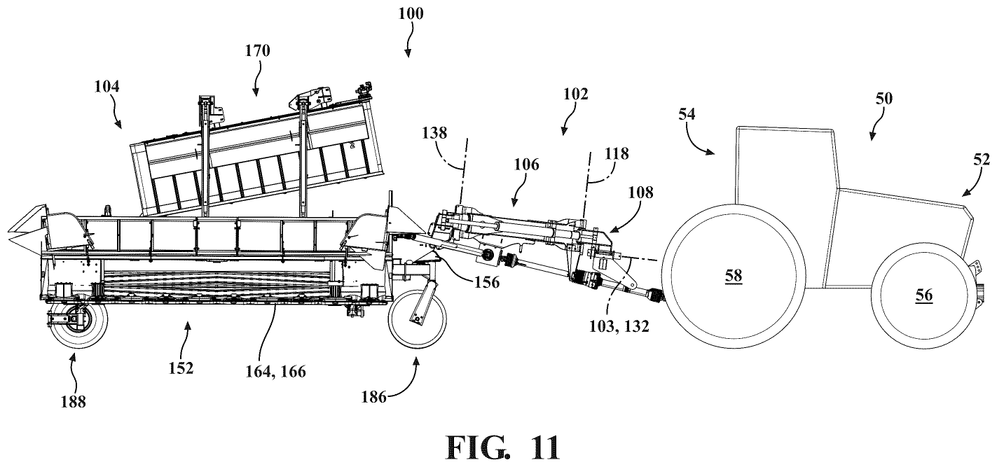

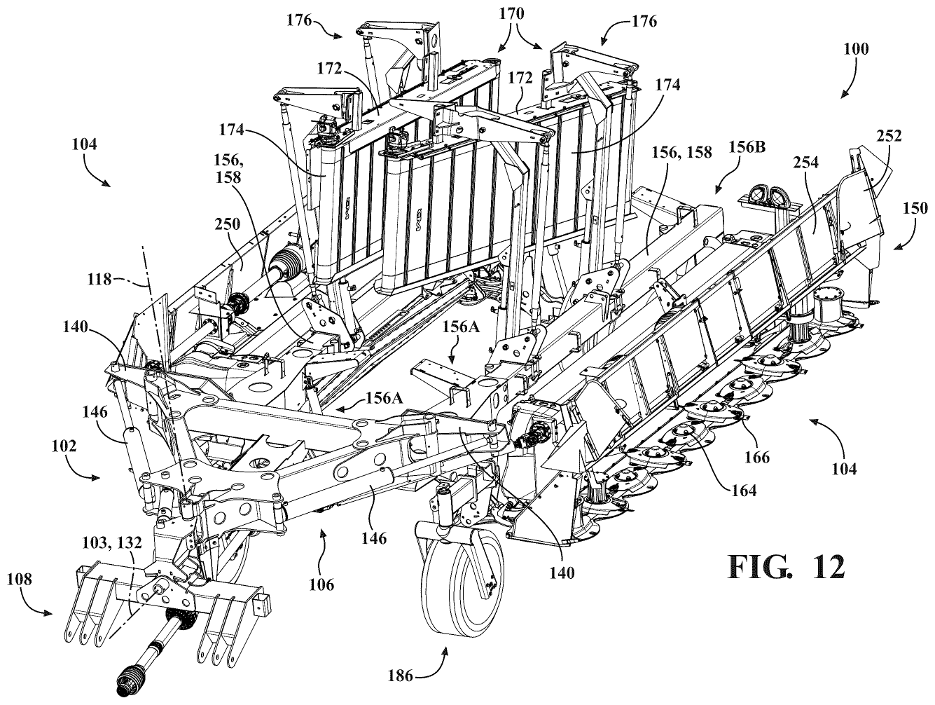

In some embodiments of the harvesting apparatus 100, each of the first header assembly 150 and the second header assembly 152 may further include a merger assembly 170, best shown in FIGS. 3 and 10. The merger assemblies 170 are operably coupled to the corresponding carrier frames 156 and arranged behind the respective header frames 162 to received cut crops. Crops that have been cut by the cutterbar are ejected from the header frame 162 toward the corresponding merger assembly 170, which moves the crops inward toward the middle of the crop harvesting apparatus 100, i.e., coupler roll axis 132. Each merger assembly 170 includes a merger frame 172 and a conveyer belt 174 operably coupled to the merger frame 172. The conveyer belt 174 moves cut crops that have been ejected from the header frame 162 towards the middle of the crop harvesting apparatus 100 to produce a windrow, which may be later collected by other harvesting equipment. As with above, each of the merger assemblies 170 is movable between a field position (FIG. 10) and a transport position (FIGS. 11 and 12). In the field position, the merger assembly 170 is positioned behind the respective header frame 162 and in the transport position, the merger assembly 170 is positioned above the respective carrier frame 156. It should be appreciated that other embodiments of the harvesting apparatus (not shown) may not include the merger assemblies.

In order to move each of the merger assemblies 170 between the field position and the transport position, the header assemblies 150, 152 further include a merger linkage 176 coupled between the merger assembly 170 and the carrier frame 156. More specifically, each merger linkage 176 is coupled between the merger frame 172 and the top beam 158 of the corresponding carrier frame 156. The merger linkage 176 includes one or more merger lift links 178 that are pivotably coupled to the merger frame 172 at one end and pivotably coupled to the top beam 158 at an opposing end. Each merger linkage 176 further includes one or more merger lift actuators 180 coupled between the top beam 158 of the carrier frame 156 and one of the merger lift links 178. The exemplary merger lift actuators 180 illustrated herein are hydraulic actuators, which are selectively movable between an extended position and a retracted position to actuate the merger linkage 176 and move the corresponding merger assembly 170 between the transport position and the field position.

Each of the header assemblies 150, 152 are supported by wheels for movement along the ground. More particularly, the header assemblies 150, 152 are each supported by an inner wheel assembly 186 and an outer wheel assembly 188, the inner wheel assembly 186 being arranged nearer to the coupler roll axis 132 than the outer wheel assembly 188 when the crop harvesting apparatus 100 is in the field position. Each of the inner wheel assembly 186 and the outer wheel assembly 188 may be coupled to the carrier frame 156. Specifically, in the exemplary implementation illustrated herein, the inner wheel assembly 186 is arranged at the inner end 156A of the carrier frame 156 and may be coupled to one of the side beams 160 and to the top beam 158. Similarly, the outer wheel assembly 188 is arranged at the outer end 156B of the carrier frame 156 and may be coupled to one of the side beams 160. Additionally, each of the inner wheel assembly 186 and the outer wheel assembly 188 are movable between a field position and a transport position generally corresponding to the corresponding positions of the arm sections 104. As will be discussed in further detail below, when the harvesting apparatus 100 is operating in a field with the arm sections 104 in the field position, the wheel assemblies 186, 188 are positioned in the field position and when the harvesting apparatus 100 is being transported between harvesting locations with the arm sections 104 in the transport position, the wheel assemblies 186, 188 are positioned in the transport position.

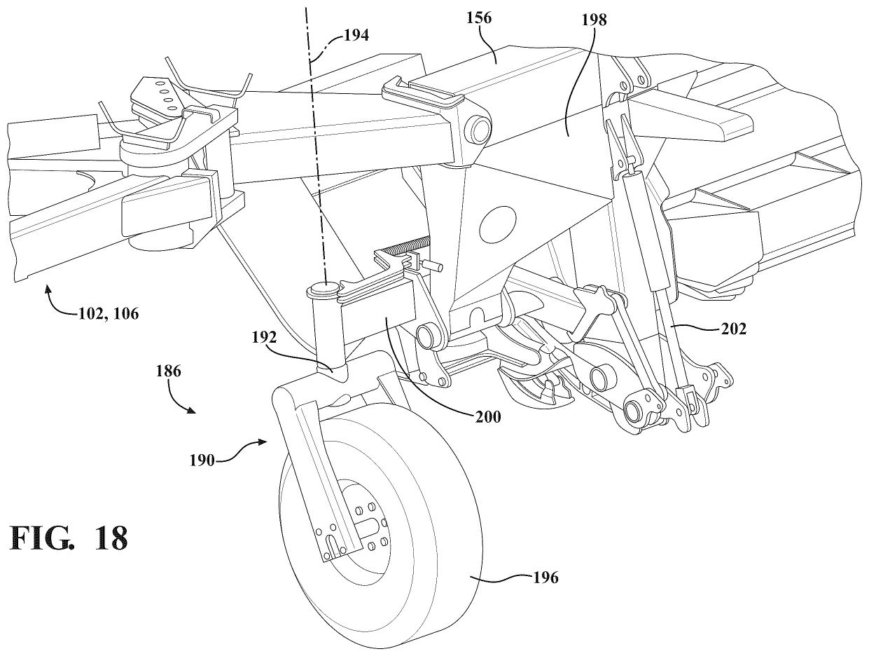

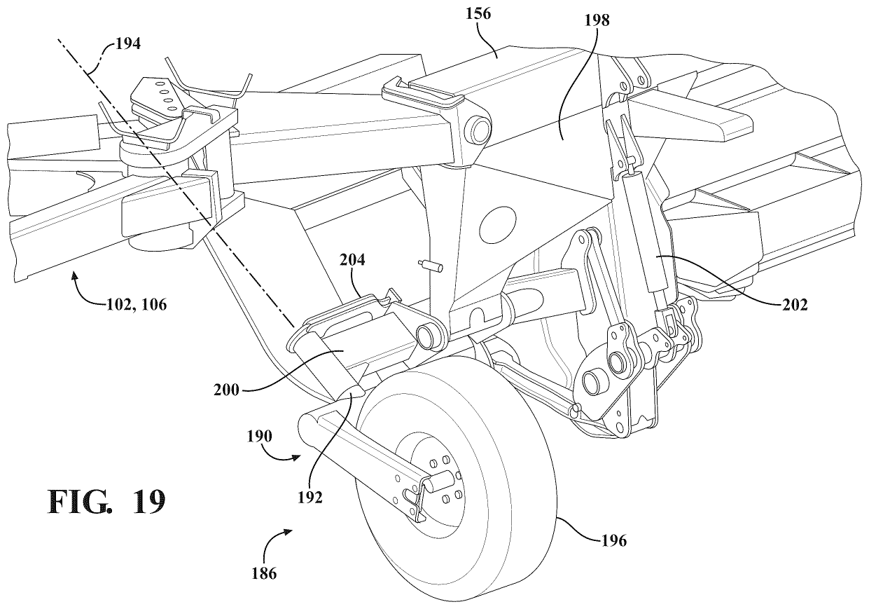

Referring to FIGS. 18-19, the inner wheel assembly 186 is shown in greater detail. Specifically, the inner wheel assembly 186 is shown in the field position in FIG. 18 and in the transport position in FIG. 19. The inner wheel assembly 186 includes a caster assembly having a fork 190, which includes a stem 192 defining a swivel axis 194. The caster assembly further includes a wheel 196 rotatably supported by the fork 190. The inner wheel assembly 186 further includes a bracket member 198, a wheel pivot assembly 200, a pivot actuator 202, and a swivel lock 204. The bracket member 198 is fixedly coupled to the carrier frame 156 and supports the wheel pivot assembly 200 for actuating the inner wheel assembly 186 between the field position and the transport position. The wheel pivot assembly 200 is operably supported by the bracket member 198 and actuated by the pivot actuator 202, which is coupled between the wheel pivot assembly 200 and the carrier frame 156. The stem 192 of the fork 190 is coupled to the wheel pivot assembly 200 such that the fork 190 is rotatable about the swivel axis 194. The swivel lock 204 is coupled to the wheel pivot assembly 200 and engageable with the stem 192 to prevent rotation of the fork 190 about the swivel axis 194. Said differently, when the swivel lock 204 is engaged with the stem 192 the fork 190 is prevented from rotating about the swivel axis 194, and when the swivel lock 204 is disengaged from the stem 192 the fork 190 is able to rotate about the swivel axis 194.

Best shown in FIG. 18, when the inner wheel assembly 186 is in the transport position the swivel axis 194 is oriented in a generally upright or vertical direction. When the swivel axis 194 is oriented in the generally upright or vertical direction (i.e., the transport position), the caster assembly is able to rotate (i.e., swivel) about the swivel axis 194. Said differently, in the transport position the fork 190 is able to rotate about the swivel axis 194 such that the wheel 196 is able to face a different direction in response to movement of the harvesting apparatus 100 along the ground. Rotation about the swivel axis 194 allows the harvesting apparatus 100 to change direction more easily while being transported. Conversely, and as best shown in FIG. 19, when the inner wheel assembly 186 is in the field position the swivel axis 194 is pivoted in a forward direction to an angled position relative to the ground. When the swivel axis 194 is oriented in the angled position (i.e., the field position), movement of the harvesting apparatus 100 along the ground does not cause the caster assembly to rotate about the swivel axis 194. Said differently, in the transport position the fork 190 does not rotate about the swivel axis 194 to change the direction of the wheel 196.

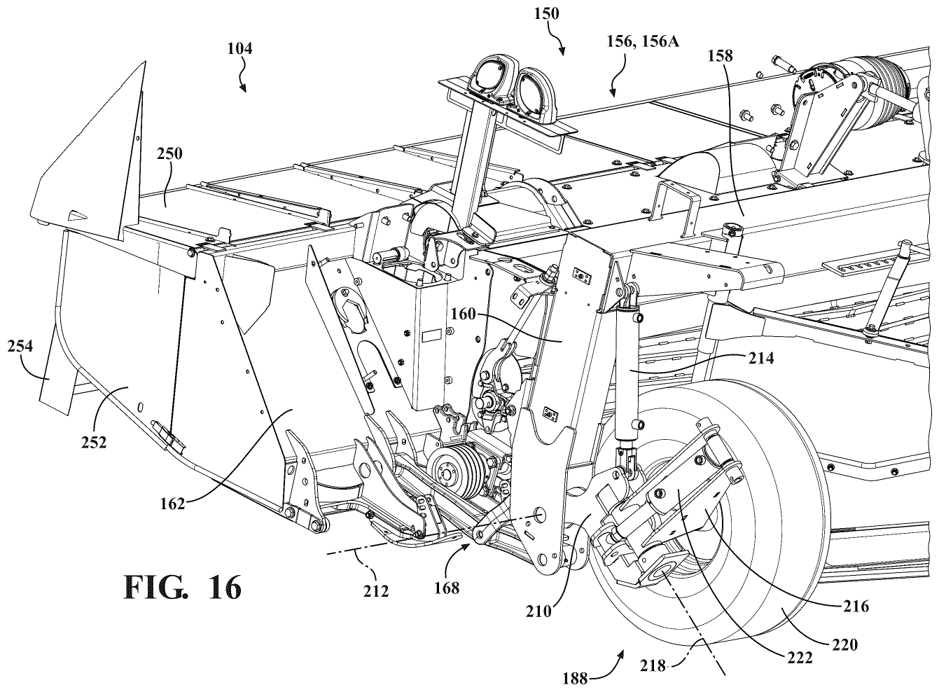

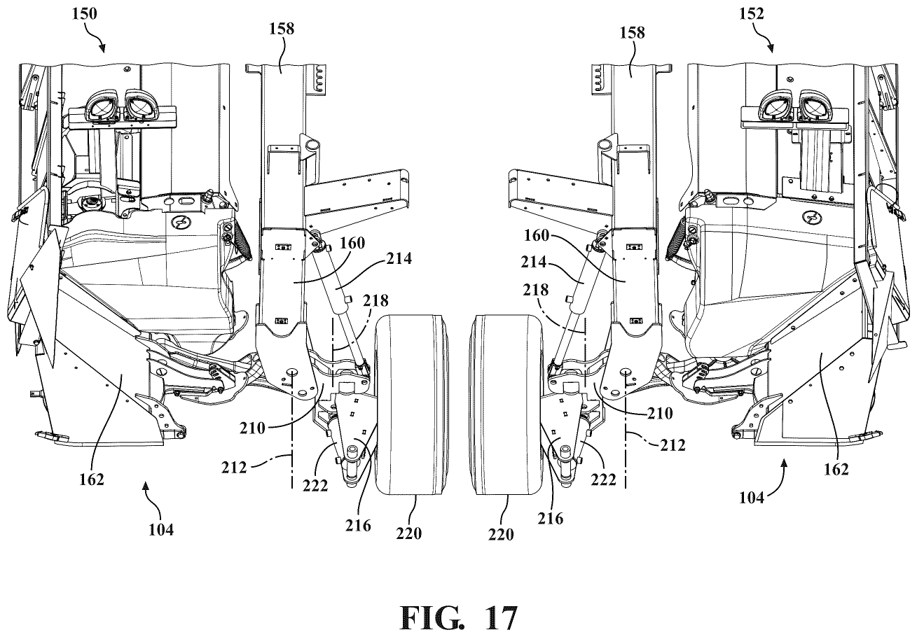

Turning now to FIGS. 16-17, further details of the outer wheel assembly 188 are shown. The outer wheel assembly 188 is coupled to the side beam 160 of the carrier frame 156 and arranged at the outer end 156B thereof. The outer wheel assembly 188 includes a first pivot bracket 210 pivotably coupled to the side beam 160. The first pivot bracket 210 is pivotable about an outer height axis 212, which is perpendicular to the suspension axis 144. Said differently, when the arm sections 104 are in the field position the outer height axis 212 extends in a lateral direction from the inner end 156A to the outer end 156B of the carrier frame 156. A wheel height actuator 214 is coupled between the carrier frame 156 and the first pivot bracket 210 to pivot the first pivot bracket 210 between a raised position and a lowered position to raise and lower the corresponding header assembly 150, 152 relative to the ground.

The outer wheel assembly 188 further includes a second pivot bracket 216 pivotably coupled to the first pivot bracket 210 and an outer wheel 220 rotatably coupled to the second pivot bracket 216. The second pivot bracket 216 is pivotable about an outer pivot axis 218, which is parallel to the coupler yaw axis 118. Said differently, the second pivot bracket 216 is pivotable about the outer pivot axis 218 between a field position and a transport position. Referring to FIG. 17, in the transport position, the outer wheel 220 is arranged to roll in a direction generally parallel to the top beam 158 of the carrier frame 156 to facilitate operation of the harvesting apparatus 100 in the transport position. Specifically, a wheel angle 232 between the outer wheel 220 rolling direction and the top beam 158 is approximately 0 degrees when the second pivot bracket 216 is in the transport position. Conversely, when the second pivot bracket 216 is in the field position, the outer wheel 220 is arranged to roll in a direction that facilitates operation of the harvesting apparatus 100 in the field position. Specifically, when the harvesting apparatus 100 and the second pivot bracket 216 are in the field position, the wheel angle 232 of the outer wheel 220 is increased. In FIG. 3, the wheel angle 232 is greater than 90-degrees such that the outer wheels 220 roll in a slightly outward direction relative to the centerline 103 of the harvesting apparatus 100. Orienting the outer wheels 220 with the wheel angle 232 greater than 90-degrees improves operation of the harvesting apparatus 100 compared to the outer wheels 220 being oriented with the wheel angle 232 at 90-degrees. An outer wheel actuator 222 is coupled between the first pivot bracket 210 and the second pivot bracket 216 and operable to move the second pivot bracket 216 between the field position and the transport position. As will be discussed in further detail below, the transport position of the second pivot bracket 216 generally corresponds to the transport position of the arm sections 104 and the field position of the second pivot bracket 216 generally corresponds to the field position of the arm sections 104.

As described above, various components of the harvesting apparatus 100 are movable between a field position and a transport position to allow the harvesting apparatus 100 to be sufficiently wide, thereby improving harvesting efficiency, and also sufficiently narrow to aid in transportation between harvesting locations. The steps below describe the process to transform the harvesting apparatus 100 from the field position to the transport position. In some implementations of the harvesting apparatus 100, some of these steps may be performed simultaneously. Each of the steps may be initiated manually by an operator or automatically by a controller. From the field position, as shown in FIG. 16, the outer wheel assemblies 188 are moved from the field position to the transport position by actuating the wheel height actuators 214 and the outer wheel actuators 222. Actuating the wheel height actuators 214 pivots the first pivot bracket 210 to raise the respective carrier frame 156 and the outer wheel actuators 222 pivots the second pivot bracket 216 to pivot the outer wheel 220 approximately 90 degrees into the transport position. Similarly, the inner wheel assemblies 186 are moved from the field position to the transport position by actuating the pivot actuator 202. The pivot actuator 202 pivots the stem 192 upward such that the swivel axis 194 is approximately vertical, thereby allowing the fork 190 to rotate about the swivel axis 194 and change the direction of the inner wheel 196. Actuation of the pivot actuator 202, the wheel height actuator 214, and the outer wheel actuator 222 may be simultaneous, staged, timed, and in any order. Said differently, the pivot actuator 202 and the height actuator 214 may be actuated at the same time and the outer wheel actuator 222 may be actuated subsequently. This order may be reversed or otherwise reordered.

Another step of moving the harvesting apparatus 100 between the field position and the transport position includes folding the top wall 250, sidewalls 252, and front curtain 254 of each of the header assemblies 150, 152. As described above, this includes pivoting the top wall 250 upwards and pivoting the sidewalls 252 inward to decrease the width of the harvesting apparatus 100 in the transport position. Conversely, when moving the harvesting apparatus 100 from the transport position to the field position, the top wall 250, sidewalls 252, and front curtain 254 are unfolded. In other words, pivoting the top wall 250 downwards and pivoting the sidewalls 252 outwards.

In another step of moving the harvesting apparatus 100 between the field position and the transport position, each of the merger lift actuators 180 are actuated to lift the merger assemblies 170 above the carrier frames 156. More specifically, each of the merger lift actuators 180 are moved from a retracted position to an extended position, which moves the merger linkages 176 and respective merger frames 172 from the field position for receiving cut crops, as shown in FIG. 1, to the transport position, as shown in FIG. 12. Moving the merger assemblies 170 above the carrier frames 156 allows each of the first header assembly 150 and the second header assembly 152 to be positioned closer together while in the transport position.

When the merger assemblies 170 have been lifted to a height sufficient to avoid colliding, the arm sections 104 can be moved from the field position to the transport position. More specifically, the wing actuators 146 can be moved from a retracted configuration to an extended configuration, which causes each of the wing members 140 to pivot about the respective wing pivot axis 138. Pivoting movement of the wing members 140 about the respective wing pivot axes 138 causes the corresponding carrier frames 156 to pivot about the respective wing pivot axis 138 with the outer ends 156B of each carrier frame 156 following an arcuate path from the field position to the transport position. In the field position, the outer ends 156B of each carrier frame 156 are spaced further from the coupler roll axis 132 than in the transport position.

It should be appreciated that the field position and the transport position may be configured differently than shown. For example, the arm sections 104 are shown perpendicular to the coupler roll axis 132 in the field position and parallel to the coupler roll axis 132 in the transport position, however the arm sections may be angled slightly away from perpendicular or parallel in the field and transport positions. In the field position, the arm sections 104 may be angled slightly rearwardly away from the tractor 50 in a V-shaped arrangement. This V-shaped arrangement of the arm sections 104 improves stability of the harvesting apparatus 100 when operating in the field position. Specifically, stability about the coupler yaw axis 118 is improved because each of the arm sections 104 generates a self-centering force on the center section 102.

The V-shaped arrangement of the arm sections 104 may be inherent to the geometry of the center section 102 (i.e., movement of the arm sections 104 to a perpendicular position is mechanically prevented) or may be controlled by the wing actuators 146. The wing actuators 146 may further adjust the angle of the arm sections 104 to improve operation of the harvesting apparatus 100 during certain conditions. For example, the wing actuators 146 may slightly pivot one arm section 104 forward toward the tractor 50 and one arm section 104 rearward away from the tractor 50 while turning. By pivoting the arm sections 104 in opposite directions the entire harvesting apparatus 100 is biased to one side away from the longitudinal tractor axis 60.

More specifically, the harvesting apparatus 100 may be positioned into a turning position. Best shown in FIG. 14, the wing members 140 are pivotable into a turn configuration in which the wing members 140 are pivoted in the same direction relative to the centerline 103 of the center frame 106. Said differently, both wing members 140 are pivoted in a clockwise direction such that one of the arm sections 104 is moved forward relative to the center section 102 and the other of the arm sections 104 is moved rearward relative to the center section 102. By moving the wing members 140 into the turn configuration, the cutting path of the harvesting apparatus 100 is biased to one side of the tractor axis 60. When the tractor 50 is turning, moving the wing members 140 into the turn configuration pivots the center frame 106 about the yaw axis 118 and biases the centerline 103 of the harvesting apparatus 100 away from the tractor axis 60, which allows the arm sections 104 to follow different arcs and overlap with the arc followed by a harvesting apparatus mounted to the front 52 of the tractor, thereby reducing missed crops. A sensor (not shown) may be coupled to the tractor 50 or the coupler frame 108 to measure the angle between the tractor 50 and the harvesting apparatus 100 and determine when the tractor 50 is turning. The harvesting apparatus 100 may dynamically adjust the angle of the arm sections 104 in response to the angle measured by this sensor. Additionally, the harvesting apparatus 100 may include a crop sensor (not shown) capable of identifying cut and uncut crops. The crop sensor may provide feedback to a controller of the position of the header assemblies 150, 152 relative to the cut and uncut crops and the controller may automatically adjust the position of the arm sections 104 to avoid missing crops. The crop sensor may be implemented as a vision sensor or a vision system coupled to the harvesting apparatus 100 or to the tractor 50.

The harvesting apparatus 100 may be operated behind a tractor 50 using one or more of the following steps to efficiently harvest crops. With the arm sections 104 in the transport position and the first and second header assemblies 150, 152 arranged behind the center frame 106, operating the wing actuators 146 to pivot the wing members 140 from the transport position to the field position such that the first and second header assemblies 150, 152 are arranged on opposing sides of the center frame 106. When the tractor 50 needs to turn, such as at the end of a row of crops, the wing actuators 146 may be operated in response to the tractor 50 turning to pivot one of the wing members 140 to move the first header assembly 150 forward relative to the center frame 106 and pivot the other of the wing members 140 to move the second header assembly 152 rearward relative to the center frame 106. More specifically, a first wing member 140A associated with the first header assembly 150 is pivoted to move the first header assembly 150 forward relative to the center frame 106 in response to the tractor 50 turning in a direction of the first wing member 140A. Likewise, a second wing member 140B associated with the second header assembly 150 is pivoted to move the second header assembly 152 forward relative to the center frame 106 in response to the tractor 50 turning in a direction of the second wing member 140B.

In response to pivoting the arm sections 104 to the turning configuration, the center frame 106 pivots about the yaw axis 118 relative to the coupler frame 108. Specifically, in response to the tractor 50 turning in a left direction, the center frame 106 pivots toward a right side of the tractor 50. In response to the tractor 50 turning in a right direction, the center frame 106 pivots toward a left side of the tractor 50. For example, the tractor 50 shown in FIG. 14 is making a left turn and in response to the left turn, the left wing member 140A is pivoted to move the left header assembly 150 forward relative to the center frame 106 and the right wing member 140B is pivoted to move the right header assembly 152 rearward relative to the center frame 106, and the center frame 106 is pivoted about the yaw axis 118 toward a right side of the tractor 50.

In addition to damping the pivoting motion of the center frame 106 about the yaw axis 118, the yaw damper 134 may be configured to provide additional or alternative functionality, such as manually pivoting the center frame 106 relative to the coupler frame 108. For example, the yaw damper 134 may be operable to increase in length and to decrease in length. Increasing the length of the yaw damper 134 pivots the center frame 106 about the yaw axis 118 in a clockwise direction. Likewise, decreasing the length of the yaw damper 134 pivots the center frame 106 about the yaw axis 118 in a counterclockwise direction.

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

What is claimed is:

1. A crop harvesting apparatus for use with an agricultural machine, the crop harvesting apparatus comprising:
a center frame configured to be coupled to the agricultural machine and defining a centerline;
a pair of wing members each coupled to the center frame and pivotable relative to the centerline about a respective wing axis for movement between a transport position and a field position; and
a first header assembly and a second header assembly each coupled to one of the wing members and pivotable about a respective suspension axis, wherein the first header assembly is independently pivotable from the second header assembly.

2. The crop harvesting apparatus of claim 1, wherein each of the wing axes is generally vertical.

3. The crop harvesting apparatus of claim 1, wherein each of the suspension axes is generally horizontal.

4. The crop harvesting apparatus of claim 1, wherein each of the suspension axes is oriented parallel to a direction of travel of the agricultural machine when the wing members are in the field position and each of the suspension axes is oriented perpendicular to the direction of travel of the agricultural machine when the wing members are in the transport position.

5. The crop harvesting apparatus of claim 1, wherein the wing axes are arranged nearer to the centerline of the center frame than the suspension axes.

6. The crop harvesting apparatus of claim 1, wherein each of the first and second header assemblies includes an outer wheel assembly, and wherein each outer wheel assembly is movable between a field position and a transport position.

7. The crop harvesting apparatus of claim 6, wherein when the wing members and each of the outer wheel assemblies are in the field position, a direction of travel of one of the outer wheel assemblies is non-parallel to a direction of travel of the other of the outer wheel assemblies.

8. The crop harvesting apparatus of claim 1, further comprising a first extendable driveshaft section having a first end operably supported by the center frame and a second end coupled to the first header assembly; and
a second extendable driveshaft section having a first end operably supported by the center frame and a second end coupled to the second header assembly.

9. The crop harvesting apparatus of claim 1, further comprising a neck member coupled to the center frame for pivoting movement about a coupler yaw axis; and
a coupler frame operably coupled to the agricultural machine and coupled to the neck member for pivoting movement about a coupler roll axis, wherein the coupler roll axis is perpendicular to the coupler yaw axis.

10. The crop harvesting apparatus of claim 9, further comprising a yaw damper coupled between the center frame and the coupler frame and movable in response to pivoting movement of the center frame about the coupler yaw axis.

11. The crop harvesting apparatus of claim 1, wherein the wing members are pivotable to a turn configuration in which the wing members are pivoted in the same direction relative to the centerline of the center frame.

12. The crop harvesting apparatus of claim 11, further comprising a coupler frame operably coupled to the agricultural machine and pivotably coupled to the center frame; and
a yaw damper coupled between the center frame and the coupler frame and movable in response to pivoting movement of the center frame about a coupler yaw axis.

13. A crop harvesting apparatus for use with an agricultural machine, the crop harvesting apparatus comprising:
a center frame configured to be coupled to the agricultural machine;
a first wing member and a first header assembly coupled to the center frame and pivotable about a first wing axis for movement between a transport position and a field position; and
a second wing member and a second header assembly coupled to the center frame and pivotable about a second wing axis for movement between a transport position and a field position;
wherein the first wing member and the second wing member are independently pivotable.

14. The crop harvesting apparatus of claim 13, wherein the first header assembly is pivotably coupled to the first wing member and pivotable about a first suspension axis, and wherein the second header assembly is pivotably coupled to the second wing member and pivotable about a second suspension axis.

15. The crop harvesting apparatus of claim 14, wherein the first and second suspension axes are perpendicular to the first and second wing axes.

16. A method for operating a crop harvesting apparatus behind an agricultural machine, the crop harvesting apparatus having a center frame, a first wing member and a second wing member each coupled to the center frame and pivotable about a respective vertical wing axis, and a first header assembly coupled to the first wing member and a second header assembly coupled to the second wing member, the method comprising the steps of:
pivoting the first and second wing members from a transport position in which the first header assembly and the second header assembly are arranged behind the center frame to a field position in which the first header assembly and the second header assembly are arranged on opposing sides of the center frame.

17. The method of claim 16, wherein the crop harvesting apparatus further includes a pair of wing actuators each coupled between the center frame and one of the first and second wing members for pivoting the respective wing member, the method further comprising a step of operating the wing actuators in response to the agricultural machine turning to pivot the first wing member to move the first header assembly forward relative to the center frame and to pivot the second wing member to move the second header assembly rearward relative to the center frame to adjust a harvesting path of the crop harvesting apparatus.

18. The method of claim 17, wherein the step of step of operating the wing actuators in response to the agricultural machine turning is further defined as pivoting the first wing member to move the first header assembly forward relative to the center frame in response to the agricultural machine turning in a direction of the first wing member, and pivoting the second wing member to move the second header assembly forward relative to the center frame in response to the agricultural machine turning in a direction of the second wing member.

19. The method of claim 17, wherein the crop harvesting apparatus further includes a crop sensor, the method further comprising a step of identifying uncut crops and operating the wing actuators to pivot the wing members relative to the center frame to adjust the harvesting path of the crop harvesting apparatus.

20. The method of claim 17, wherein the crop harvesting apparatus further includes a coupler frame operably coupled to the agricultural machine and pivotably coupled to the center frame, the method further comprising a step of pivoting the center frame toward a right side of the agricultural machine in response to the agricultural machine turning in a left direction, and pivoting the center frame toward a left side of the agricultural machine in response to the agricultural machine turning in a right direction.
